(19) United States
(12) Patent Application Publication
(10) Pub. No.: US 2017/0363833 A1
(43) Pub. Date: Dec. 21, 2017

(54) POLYMER-FREE COMPLIANT OPTICAL MEMBER SUPPORT

(71) Applicant: Corning Incorporated, Corning, NY (US)

(72) Inventor: Brian Monroe McMaster, Pittsford, NY (US)

(21) Appl. No.: 15/604,744

(22) Filed: May 25, 2017

Related U.S. Application Data
(60) Provisional application No. 62/351,426, filed on Jun. 17, 2016.

(51) Int. Cl. G02B 7/02; C09J 1/00

(52) U.S. Cl. CPC G02B 7/026; C09J 1/00; G02B 7/028

(57) ABSTRACT

An assembly for fixing an optical element in a manner that decouples the optical element from mechanical stresses and thermal strains while providing freedom to facilitate alignment of the optical element, and while also eliminating polymers that can cause contamination problems including a mount configured for attachment to an optical system; a plurality of flexible metal members, each flexible member having a first end affixed to or integrally extending from the mount, and a free end defining a bearing surface for supporting an optical element; and an inorganic adhesive joining a surface of the optical member to the bearing surface.

This application claims the benefit of priority under 35 U.S.C. §119 of U.S. Provisional Application Ser. No. 62/351,426 filed on Jun. 17, 2016 the content of which is relied upon and incorporated herein by reference in its entirety.

### FIELD OF THE DISCLOSURE

This disclosure pertains to support structure for optical elements, and more particularly to compliant support structure for optical elements that effectively decouples the optical member from stresses and thermal strain.

### BACKGROUND OF THE DISCLOSURE

Industry practice for mounting optical elements, such as precision lenses for lithographic equipment, involves the use of compliant material to fixate a lens to a mount. The compliant material reduces induced deformations to the optical element when the mount is subjected to mechanical stresses or thermal strain.

Typically, the compliant material is a plastic comprised of an organic polymer that will bond to the optical element. Further, whether the compliant material comprises an organic polymer or an inorganic material, such as metal, the compliant material linking the optical member to the mount is typically secured to the optical member using an organic adhesive, such as an epoxy resin or a cyanoacrylate resin.

In certain optical systems, organic polymers can create contamination problems that degrade performance of the optical elements.

### SUMMARY OF THE DISCLOSURE

Disclosed is a support structure to fixate an optical element in a manner that decouples the optical element from mechanical stresses and thermal strain while providing a desirable degree of freedom to facilitate alignment of the optical element in order to allow proper functioning of the optical element, while also eliminating polymers from the compliant material and adhesive.

The optical element assembly includes an optical element mount that can be configured for rigid attachment to an optical system, such as the lens housing of an optical system of a lithographic machine; a plurality of flexible metal members, each flexible metal member having a first end affixed to or integrally extending from the mount, and a free end defining a bearing surface for supporting an optical element; and an optical element joined to each of the bearing surfaces of the flexible members with an inorganic adhesive.

### BRIEF DESCRIPTION OF THE DRAWINGS

FIG. 1 is a sectioned perspective view of an assembly for mounting an optical element in accordance with this disclosure.

FIG. 2 is a sectioned perspective view of an alternative assembly for mounting an optical element in accordance with this disclosure.

FIG. 3 is a schematic illustrating details of an adhesive attachment of a lens to a flexible metal member in accordance with this disclosure.

FIG. 4 is a schematic illustrating details of an alternative adhesive attachment of a lens to a flexible metal member in accordance with this disclosure.

FIG. 5 is a perspective view of a further alternative assembly for mounting an optical element in accordance with this disclosure.

### DETAILED DESCRIPTION

The disclosed optical element assembly employs an inorganic adhesive to affix an optical element to flexible metal members that act like springs to decouple deformations between the lens and the lens mount, while also facilitating precise alignment and avoiding contamination problems that can occur when organic materials are employed.

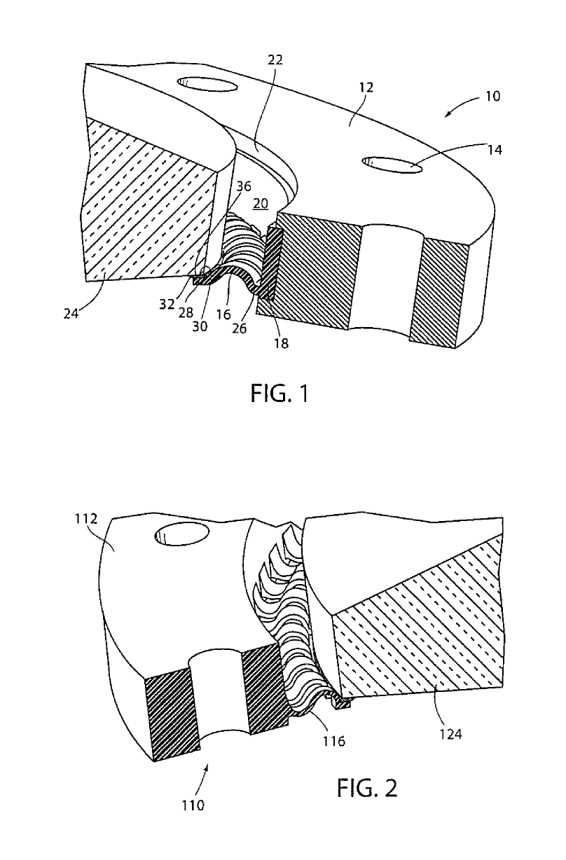

FIG. 1 shows an embodiment of an optical element assembly 10 in accordance with this disclosure. Assembly 10 includes a mount 12 having a ring-shape and defining attachment features or holes 14 for affixing the mount to an optical system, such as a housing for a combination of optical elements used in a lithography apparatus, using screws or other fasteners. Alternative attachment features may be used to facilitate a rigid attachment of the mount to an optical system using clamps or other securement devices. In the embodiment shown in FIG. 1, flexible metal members 16 are an integral portion of a retainer 18 having a ring-shaped wall portion 20 that abuts and is secured to an inner circumferential wall 22 of ring-shaped mount 12. Flexible members 16 extend radially inwardly and substantially perpendicularly from wall 20 toward an optical axis of an optical element 24. The “optical axis” refers to a line that extends perpendicularly through a center of a plane of main extension of the optical element. The flexible members 16 are spaced apart and have a thickness suitable to allow flexure of the flexible members to effectively isolate and decouple the optical element 24 from mechanical stresses and thermal strains. Flexible members 16 have an inverted U-shape profile to impart resilience, springiness and/or rebound properties.

Integral wall 20 and flexible members 16 of retainer 18 are formed of a metal that can be secured to wall 22 of mount 12 with fasteners (e.g., screws), a frictional interference fit, and/or with an inorganic (or organic) adhesive. A first end 26 of each flexible member 16 extends integrally from wall 20, and an opposite free end 28 defines an upper bearing surface 30 for supporting optical element 24.

An inorganic adhesive 32 is disposed on the bearing surface 30 between flexible members 16 and corresponding surfaces of optical element 24 to secure optical element 24 on retainer 18, such that optical element 24 is held by mount 12, yet decoupled from mechanical stresses and thermal strains by the flexible members 16 of retainer 18.

As used herein, an “inorganic adhesive” is a substance capable of holding materials together by surface attachment. Additionally, as used herein, an “inorganic adhesive composition” or “inorganic adhesive composition precursor” is an adhesive or precursor to an adhesive, respectively, which contains inorganic materials, usually a majority by weight of inorganic materials, such as metal oxides, other inorganic additives, or both. Inorganic adhesive compositions, as described herein, may contain some amount of organic material, such as organic adhesion promoters. However, in one embodiment, the inorganic adhesive composition may generally comprise a ceramic material. In some embodiments, the inorganic adhesive composition may comprise one or more metal oxides such as, but not limited to, oxides of zinc, tin, aluminum, indium, iron, tungsten, titanium, zirconium, silicon, silicon nitride, boron, boron nitride, copper, silver, yttrium, rare earth ions, or combinations thereof. The inorganic adhesive may comprise one or more metal oxides doped with one or more other metal oxides, such as yttria-stabilized zirconia, sometimes referred to herein as “YSZ.”

The optical element may be secured to the flexible members 16 by a method generally comprising depositing an inorganic adhesive composition precursor onto the optical element 24 and/or onto the bearing surface 30 and then bringing the optical element 24 and bearing surface 30 into contact with each other and solidifying the inorganic adhesive composition precursor to form an inorganic adhesive composition.

The inorganic adhesive composition precursor may comprise a metallic salt or other metal ion containing compound in a solvent. The metallic salt and/or other metal ion containing compound may comprise ions of zinc, tin, aluminum, indium, iron, tungsten, titanium, zirconium, silicon, silicon nitride, boron, boron nitride, copper, silver, yttrium, rare earth ions, or combinations thereof. In one embodiment, the metallic salt and/or or other metal ion containing compound may comprise ions of zirconium, yttrium, or both.

In some embodiments, the solvent may be a polar aprotic solvent. The polar aprotic solvents described herein have ion solvating properties that facilitate the process of making a stable inorganic adhesive composition precursor. The inorganic adhesive composition precursor may be a sol-gel solution. The sol-gel described herein may be different from traditional sol-gel chemistry in several important ways. For example, the proposed material reaction to form the sol-gel solution may not use alcohol solvents or conventional water/acid catalysis. Instead, the reaction may utilize metal salt concentrations in polar aprotic solvents (e.g. DMF, NMP) at relatively high concentration (0.5-2.0 M).

Polar aprotic solvents such as, for example, dimethylformamide (DMF) and n-methyl pyrrolidone (NMP), can be used to produce stable precursor solutions with metal salts and/or other metal ion containing compounds. Polar aprotic solvents may be described as solvents that share ion dissolving power with protic solvents but lack an acidic hydrogen. These solvents generally have intermediate dielectric constants and polarity. Aprotic solvents do not commonly display hydrogen bonding or have an acidic hydrogen. They are commonly able to stabilize ions. Examples of suitable polar aprotic solvents include dichloromethane (DCM), tetrahydrofuran (THF), ethyl acetate, acetone, dimethylformamide (DMF), acetonitrile, and dimethylsulfozide (DMSO).

Various metal oxides can be included in the inorganic adhesive composition based on the components of the inorganic adhesive composition precursor. For example, an inorganic adhesive composition comprising YSZ can be prepared by utilizing an inorganic adhesive composition precursor. Such an inorganic adhesive composition precursor may be prepared by mixing a first zirconia containing metal salt solution and a second yttria containing salt solution. The first solution may include zirconium oxychloride octohydrate (Zr(OCl₂).8H₂O, >99% from Sigma-Aldrich) dissolved in N,N-dimethylformamide (DMF). The second solution may include Yttrium Chloride (YCl₃ from Sigma Aldrich) dissolved in N,N-dimethylformamide (DMF). The first and second solutions may be prepared with molar concentrations having stoichiometry to achieve a ratio between the atom % values of Zirconia and Yttrium. For example, samples may contain 1%, 2%, 4% and 8% atom content of Yttrium in Zirconia. An ultrasonic bath may be used to facilitate mixing. The inorganic adhesive composition precursor may be clear and of significant viscosity.

An advantage of the inorganic adhesive compositions disclosed herein is the stability of the inorganic adhesive composition precursor. The inorganic adhesive composition precursor can be stored in ambient conditions for at least a month without significant degradation of the sol-gel chemical structure of the metal ions or the solvent.

The inorganic adhesive composition precursor is converted into the inorganic adhesive composition through a solidification step. The solidification may comprise exposing the inorganic adhesive composition precursor to a temperature in a range of from about 200° C. to about 1200° C. In other embodiments, the solidification may comprise exposing the inorganic adhesive composition precursor to a temperature in a range of from about 250° C. to about 1100° C., from about 300° C. to about 800° C., or from about 300° C. to about 600° C. During the solidification, the solvent may be liberated from the inorganic adhesive composition precursor and at least some of the components of inorganic adhesive composition precursor may be sintered.

The heating may be by oven, hot plate, or any other suitable heating mechanism. In some embodiments, other heating mechanisms such as microwave and inductive heating may be used. Time and temperature of such heating processes may vary depending upon the heating mechanism utilized in the solidification step. In one embodiment, the inorganic adhesive composition precursor may be heated with a laser. For example, a laser having a 40 W power rating at 810 nm focused on a spot size of approximately 2 mm may be used. However, the use of various laser powers, wavelengths, and surface areas is contemplated herein. The heating step may take less than about 3 minutes, less than about 2 minutes, less than about 1 minute, less than about 45 seconds, less than about 30 seconds, less than about 20 seconds, less than about 15 seconds, less than about 10 seconds, or even less than about 5 seconds. However, the time may be dependent upon the power of the laser and the contacting surface of the laser. The adhesive composition may then be allowed to cool by any process, such as by accelerated cooling or through cooling in an ambient atmosphere at or near room temperature.

Another embodiment 110 of the disclosed assembly for mounting an optical element is shown in FIG. 2. In this embodiment, flexible metal members 116 are integrally formed of the material forming mount 112. In other words, flexible metal members 116 and mount 112 are portions of a monolithic fixture. The structure of embodiment 110 is otherwise similar to, or substantially the same as embodiment 10. This embodiment 110 eliminates the task of affixing a retainer 18 to mount 12.

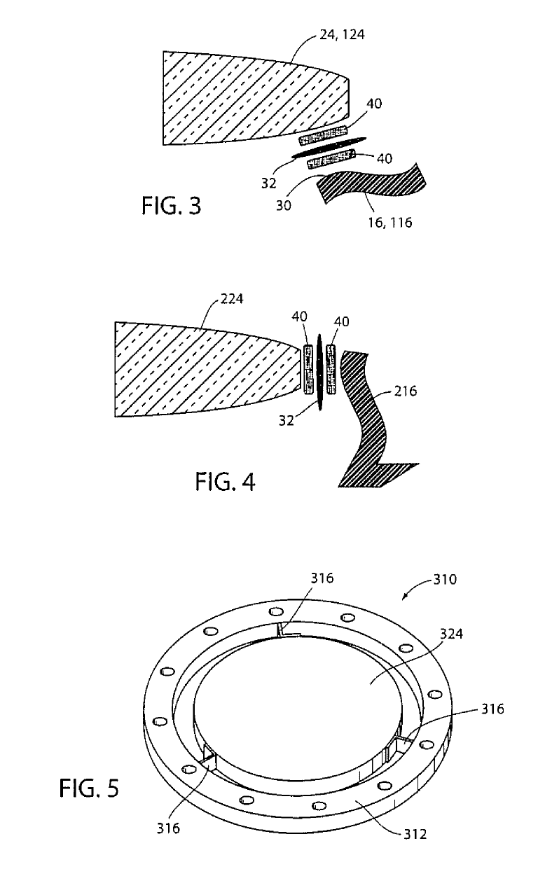

In any of the disclosed embodiments, adhesion between the optical element 24, 124 and the flexible metal members 16, 116 can optionally be enhanced by applying an adhesion promoting coating 40 to the binding surfaces of the optical element, the binding surface (bearing surface) of the flexible metal members, or both the binding surfaces of the optical element and the flexible metal members, as illustrated in FIG. 3. The adhesion promoting coating may include, without limitation, titanates (such as Tyzor 131 commercially available from DuPont), zirconates, (such as Tyzor 217 commercially available from DuPont), silanes (such as SIB 1824 and SIB 1821 commercially available from Gelest).

FIG. 4 shows an alternative mounting of an optical element 224 to a flexible metal member 216 along edge surfaces of optical member 224. These geometries are illustrative, it being apparent that a plurality of alternative geometries may be employed.

FIG. 5 shows another embodiment 310 in which flexible members 316 extend radially inwardly toward the optical axis of optical element 324 and include a lateral portion or free end that extends circumferentially and defines a bearing surface for adhesively joining the lens to the ring-shaped mount 312 while isolating the optical member from mechanical stresses and thermal strains. The flexures in FIG. 5 are articulated so that the optical element may be secured around the side perimeter of the optical element. Regardless of flexure geometry, the same optional coating(s) and binding agent can used as previously described to secure and ensure that no gripping stress is transferred to the optical element.

Unless otherwise indicated it is envisioned that any feature of any embodiment can, unless incompatible, be used in any other embodiment. Optical elements that may be employed include lens, mirrors and prisms.

The described embodiments are preferred and/or illustrated, but are not limiting. Various modifications are considered within the purview and scope of the appended claims.

What is claimed is:

1. An assembly for mounting an optical element in an optical system, comprising:
a mount configured for rigid attachment to the optical system;
a plurality of flexible metal members, each flexible metal member having a first end affixed to or integrally extending from the mount, and a free end defining a bearing surface for supporting an optical element; and
an optical element joined to the bearing surfaces of the plurality of flexible members with an inorganic adhesive.

2. The assembly of claim 1, wherein the mount has a ring-shape.

3. The assembly of claim 1, wherein the flexible metal members are integrally formed with the mount from a monolithic metal body.

4. The assembly of claim 1, wherein the mount includes attachment features for affixing the mount to an optical system.

5. The assembly of claim 1, wherein the mount includes holes for affixing the mount to an optical system.

6. The assembly of claim 1, wherein the flexible metal members are integral portions of a retainer having a ring-shaped wall abutting and secured to an inner circumferential wall of the mount.

7. The assembly of claim 1, wherein the flexible metal members have an inverted U-shape profile.

8. The assembly of claim 1, wherein adhesion between the optical element and the flexible metal members is enhanced by providing an adhesion promoting coating on the bonding surface of the optical element.

9. The assembly of claim 1, wherein adhesion between the optical element and the flexible metal member is enhanced by providing an adhesion promoting coating on the bearing surface of the flexible metal member.

10. The assembly of claim 1, wherein adhesion between the optical element and the flexible metal member is enhanced by providing an adhesion promoting coating on both the bonding surfaces of the optical element and the bearing surfaces of the flexible metal members.

11. The assembly of claim 8, wherein the adhesion promoting coating is comprised of titanates, zirconates or silanes.

12. The assembly of claim 9, wherein the adhesion promoting coating is comprised of titanates, zirconates or silanes.

13. The assembly of claim 10, wherein the adhesion promoting coating is comprised of titanates, zirconates or silanes.

14. The assembly of claim 1, wherein the inorganic adhesive comprises metal oxides.

15. The assembly of claim 14, wherein the metal oxides are selected from oxides of zinc, tin, aluminum, indium, iron, tungsten, titanium, silicon, silicon nitride, boron, boron nitride, copper, silver, yttrium, rare earth ions and combinations thereof.
